(19) United States
(12) Patent Application Publication
(10) Pub. No.: US 2022/0342106 A1
(43) Pub. Date: Oct. 27, 2022

(54) TWIN COAXIAL LEFT/RIGHT ANTENNA CONFIGURATION

(71) Applicant: The Charles Machine Works, Inc., Perry, OK (US)

(72) Inventor: Brian K. Bailey, West Des Moines, IA (US)

(21) Appl. No.: 17/728,299

(22) Filed: Apr. 25, 2022

Related U.S. Application Data
(60) Provisional application No. 63/180,216, filed on Apr. 27, 2021.

(51) Int. Cl. G01V 3/08; H01Q 1/22

(52) U.S. Cl. CPC G01V 3/081; H01Q 1/22

(57) ABSTRACT

An antenna arrangement for a locating device. The antenna arrangement includes two sets of coaxial antennas, where the sets are vertically displaced from one another. The arrangement may also include a phase reference antenna. Each antenna is parallel to each of the others. Each antenna detects the electromagnetic field, emanating from below-ground utilities, at an above ground location. Such detection may enable an operator of the arrangement to determine the presence and location of multiple underground lines.

### BACKGROUND

Locating a straight conductive line with an electromagnetic line locator is straightforward when no other conductive lines are close enough to the line being located to cause a disruption. In this case the current flowing down the line creates a cylindrical magnetic field about the axis of the conductor. The return current will be distributed through the soil around the line and will be spread out far enough that it has minimal impact on the shape of the magnetic field.

The magnetic field of the first line is not significantly affected by the introduction of a second conductive line substantially perpendicular to the first (with a few exceptions).

The magnetic field of the first line is affected by a second line parallel to the first. Now the bulk of the current flowing down the first line couples conductively or capacitively to the second line where it travels back to the signal source. When reasonably close to the signal source, this situation can be effectively modeled as two parallel lines with equal but opposite current flow.

A third basic case is when the first line carries the signal current out and the second and a third parallel line both share the return current. The magnetic fields from the second and third lines combine using superposition. When the lines are close enough together the magnetic fields from the two lines appear as one wide magnetic field making it difficult to determine the actual location of either line. The second and third lines can be effectively modeled as two parallel lines with current flow in the same direction, though not necessarily equal.

Both simplified parallel line cases can occur with equal or unequal current flow due to other conductive objects in the ground and due to the conductivity of the ground itself. The case where the two lines cross at a shallow angle also occurs but can be approximated by treating the lines as parallel.

Antennas and Configurations

The following antenna naming conventions will be used throughout this document:

| | |
|---|---|
| Peak | A horizontally oriented antenna |
| Null | A vertically oriented antenna |
| BP | Bottom Peak |
| BN | Bottom Null |
| BR | Bottom Right |
| BL | Bottom Left |
| TR | Top Right |
| TL | Top Left |
| Twin | the difference between two similar antennas |
| LR | An Antenna configuration that produces a |
| | Left-Right output |

Several different locator antenna configurations have been developed to better locate conductive underground lines. Following is a list of basic antennas and antenna configurations that are considered industry standard.

Single Peak 110—A single horizontally oriented peak antenna 102 oriented normal to the conductive line. The single peak antenna detects magnetic fields in the horizontal orientation and has a broad response. It ignores vertical magnetic field components.

Twin Peak 112—Two horizontally oriented, vertically spaced peak antennas 102 normal to the line. The twin peak signal is obtained by subtracting the top peak antenna signal from the bottom peak antenna signal. It detects magnetic fields only in the horizontal orientation and has a much sharper response than a single peak antenna. The Twin signal gets noisier as depth increases because it is a difference between the bottom peak and the top peak. This signal gets much smaller with increasing depth and requires more gain to scale it appropriately.

Null 114—A single vertically oriented null antenna 104. The null antenna 104 has a very sharp response and can be used to pinpoint the location of a line. It is very susceptible to field distortion due to nearby lines.

Below is a graphical representation of the field detected by each of the above antenna configurations, in a simple situation where a single line is located at x=0.

For clarity, in the FIG. 7, the top peak is the “Single Peak” embodiment. The peak below it is the “Twin Peak” embodiment, and the line which results in a valley where the others result in peaks is the “Null.”

The peak antennas 102 all respond to a “maximum” when directly above the line, while the null antenna 104 detects a greater signal during approach, but goes to zero when the null antenna 104 is above the line.

Several different locator antenna configurations have been developed to better locate conductive underground lines. Following is a list of antenna configurations capable of providing estimates of direction and relative distance to the line when not centered above it. These are shown in FIG. 2.

Conventional LR 120—A peak 102 and a null 104 antenna located closely together in a ‘+’ shape to form an antenna pair can be used to determine the direction and relative distance to an underground line. ARCTAN (NULL/PEAK) can be used to get the angle from vertical from the antennas to the underground line. In practice it can be approximated by (peak/Null) to give a rough horizontal magnitude. In both cases the relative phase of the null antenna to the peak can be used to determine left or right polarity.

Twin Null LR 122—A conventional Left-Right antenna pair with an additional null antenna 104 vertically spaced from the first. This configuration subtracts the top null signal from the bottom null signal and compares the result to the bottom peak antenna to approximate horizontal offset and phase. The Twin Null Left-Right configuration reduces the distortion caused by nearby parallel lines and is an improvement over conventional Left-Right.

Coaxial Peak LR 124—A bottom peak antenna 102 is used as a phase reference for left and right peak antennas, typically located farther vertically from the line, coaxial with each other, and horizontally offset equally in opposite directions.

Subtracting the left antenna signal from the right and dividing the result by the peak antenna signal gives a Left-Right signal that reasonably represents horizontal offset from the line and gives direction via relative phase. Since a conventional LR antenna ignores the vertical component of the magnetic field it is immune to distortion from perpendicular lines. It is also quite good for minimizing distortion from parallel lines.

The bottom peak phase reference antenna can be omitted and one or both of the coaxial antennas used for the phase reference but performance may be degraded.

Plots of signals from a single line for theses antenna configurations are not provided since they are very similar. Any of the Left-Right antenna configurations will perform well when only a single line is present.

### SUMMARY

The invention is directed to a locator for use in an above-ground region characterized by a magnetic field emanating from one or more below-ground utility lines. The locator comprises a first pair of antennas, a second pair of antennas, and a processor. Each pair of antennas is spaced apart along their respective first and second axes. The first axis and second axis are spaced apart and parallel. The processor is configured to receive signals indicative of the magnetic field from the first pair of antennas and second pair of antennas and, using the signals, determine a location of the below-ground utility lines.

### BRIEF DESCRIPTION OF THE DRAWINGS

FIG. 1 is a diagrammatic representation of three antenna arrangements, namely a peak, a twin peak, and a null arrangement. These are arranged from left to right.

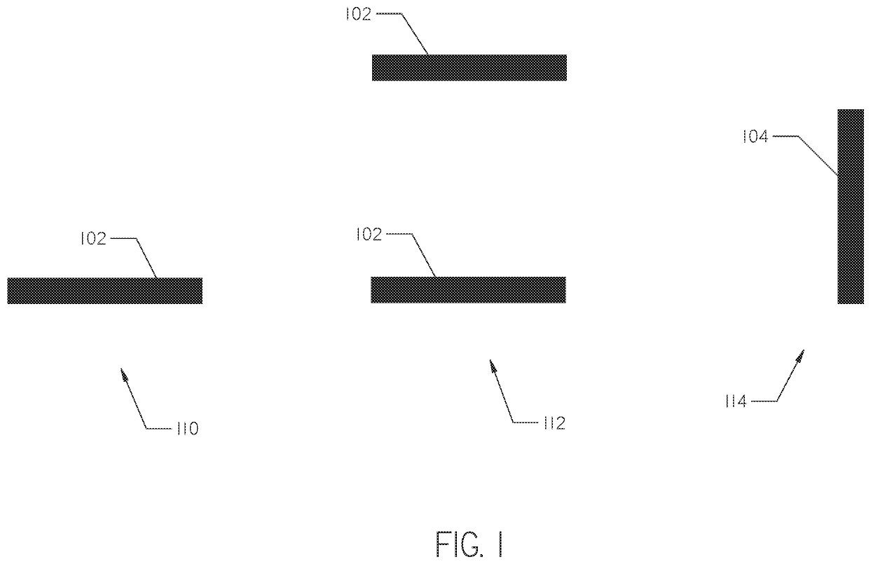

FIG. 2 is a diagrammatic representation of three antenna arrangements.

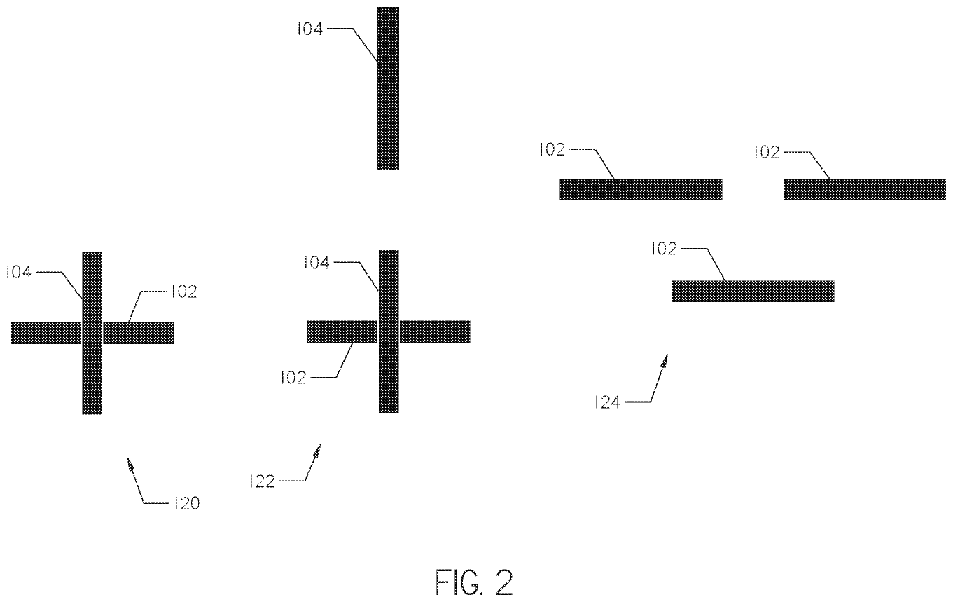

These are a peak/null arrangement, known as a “conventional LR” arrangement, a peak/null arrangement known as a “twin null LR” arrangement, and a coaxial peak LR arrangement. These are arranged from left to right.

FIG. 3 is a sectional view of internal components of a locator. Five peak antennas are shown in the locator, with two pair of antennas disposed coaxially about parallel axes.

FIG. 4A is a representation of a first field, with two underground lines shown having opposite currents, located at distances a and b away from the locator.

FIG. 4B is a representation of a second field, with two underground lines shown having same-direction currents, located at distances a and c away from the locator, where distance c is greater than distance b.

FIG. 4C is a representation of a third field, with two underground lines shown having same-direction currents, located at distances a and c away from the locator.

FIG. 5 is a diagrammatic representation of an antenna arrangement, having two pair of coaxial peak antennas.

FIG. 6 is a diagrammatic representation of an antenna arrangement, namely, the arrangement shown in FIG. 3.

FIG. 7 is a plot of magnetic field detection for various antennas, with position relative to the signal generation plotted on the X-axis and signal response plotted on the Y-axis.

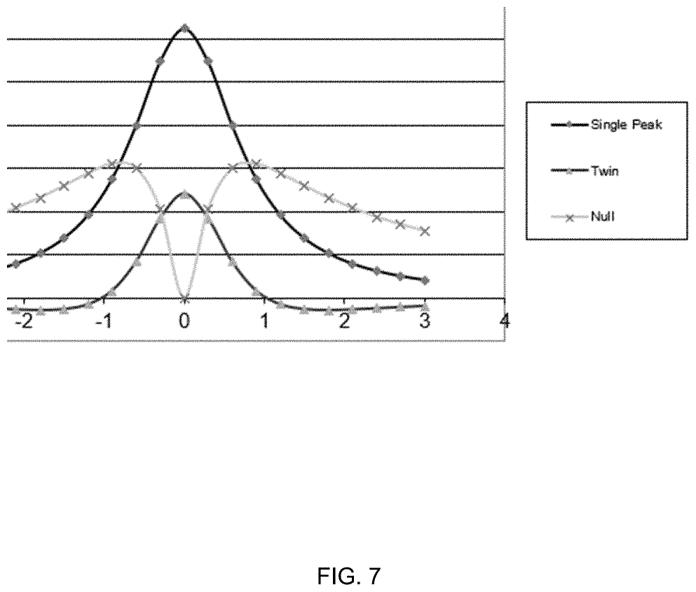

FIG. 8 is a plot of magnetic field detection for various antennas, with position relative to the signal generation plotted on the X-axis and signal response plotted on the Y-axis. In FIG. 8, the signals are generated at X=2 and X=4, as shown in FIG. 4A.

FIG. 9 is a plot of magnetic field detection for various antennas, with position relative to the signal generation plotted on the X-axis and signal response plotted on the Y-axis. In FIG. 9, the signals are generated at X=2 and X=5, as shown in FIG. 4B.

FIG. 10 is a plot of magnetic field detection for twin null, coaxial, twin, and twin coaxial LR antennas, with position relative to the signal generation plotted on the X-axis and signal response plotted on the Y-axis. In FIG. 10, the signals are generated at X=2 and X=4 as shown in FIG. 4A.

FIG. 11 is a plot of magnetic field detection for twin null, coaxial, twin, and twin coaxial LR antennas, with position relative to the signal generation plotted on the X-axis and signal response plotted on the Y-axis. In FIG. 11, the signals are generated at X=2 and X=5 as shown in FIG. 4B.

FIG. 12 is a plot of magnetic field detection for twin null, coaxial, twin, and twin coaxial LR antennas, with position relative to the signal generation plotted on the X-axis and signal response plotted on the Y-axis. In FIG. 12, the signals are generated at X=2 and X=4 as shown in FIG. 4C.

### DETAILED DESCRIPTION

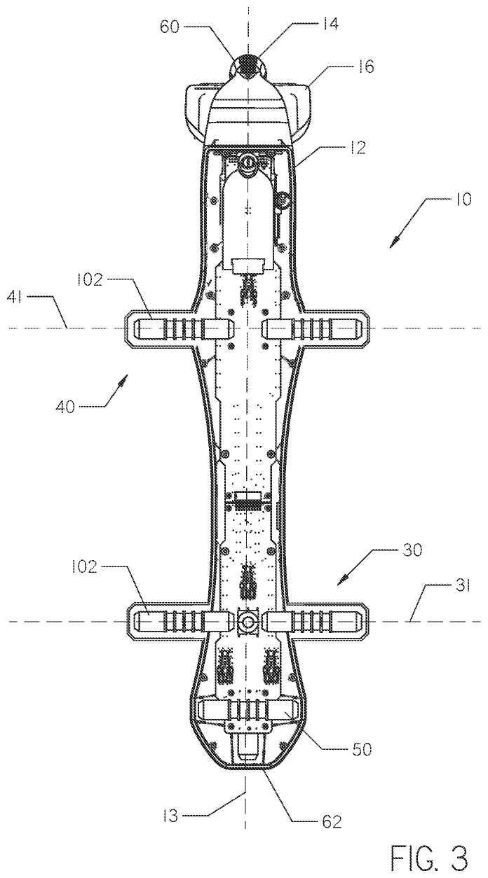

Turning now to the figures, FIG. 3 is an image of a locator 10. The locator 10 comprises a frame 12 having a height that allows vertical displacement of antenna elements relative to a surface of the ground. The frame 12 may have a handle 14 near its top to enable it to be held by an operator. A display 16 may also be at the top of the frame 12 to provide feedback to an operator concerning detection of a field.

In general, locator devices are used to detect the position and signal strength of an underground line. The position may be used to make decisions about digging—such as by a “One Call” service or otherwise. Locating underground utilities is meaningful in preventing accidental strikes.

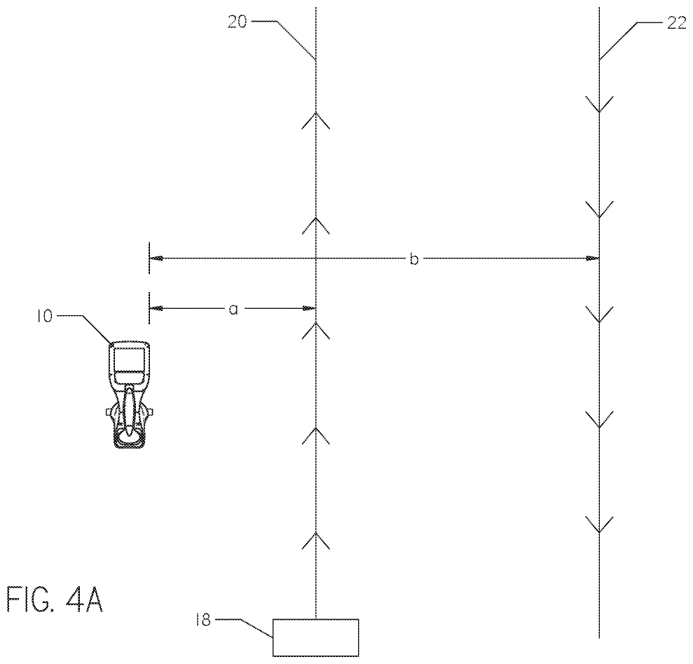

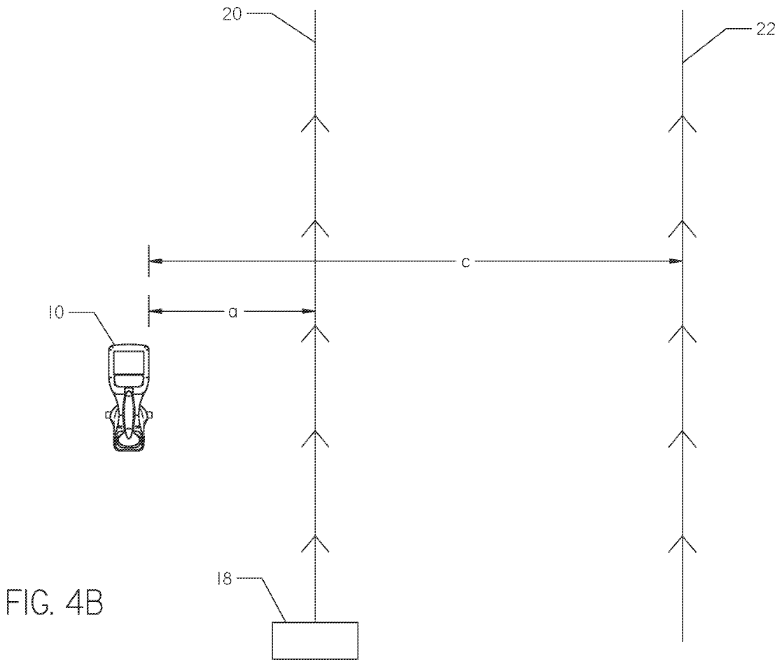

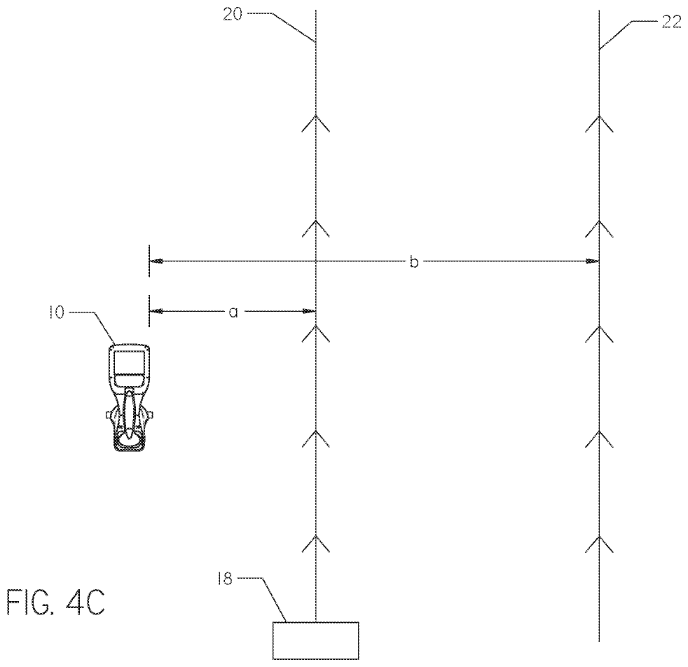

With reference to FIG. 4A-4C, the locator 10 detects the current placed on a first underground line 20 by a transmitter 18. The locator 10 then processes the detected signals to localize the 3D position of the first line 20 carrying the signal.

The locating process may be understood as a combination of signal strength measurements or signal phase comparison between a multiplicity of receiving antenna signals that can be processed by electrical signal processing circuits to provide a means to locate and pinpoint the buried utility carrying the transmitter signal. A detailed discussion of a standard locate operation is found in U.S. Pat. No. 5,264,795, issued to Rider, the contents of which are incorporated by reference herein.

The introduction of a second line 22 within a field, reasonably parallel to the first line 20 shows the differences in effectiveness between the LR antenna configurations 120, 122, 124. Parallel lines 20, 22 may have current flow in opposite directions when directly connecting to the first line (to aid in locating) and having a significant part of the current return on the parallel line. This direction is shown in FIG. 4A.

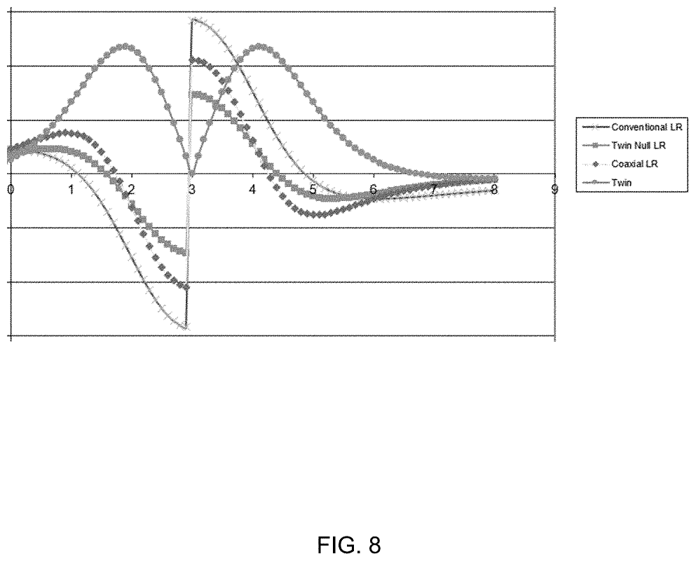

The LR configurations 120, 122, 124 have different reactions to the multi-line environment. Shown below is the reaction of these configurations to the field of FIG. 4A. In FIG. 4A, the current in the first line 20 is travelling in a first direction and located a distance “a” units away from the reference point (at which the locator 10 is represented). Current in the second line 22 is travelling in a second direction, opposite from the first direction, and at “b” units away from a reference point. In this example shown in FIG. 8, “a” may be 2 and “b” may be 4.

A Twin antenna 112 magnitude plot is shown reference. The LR signals are positive when the line 20, 22 is to the right of the locator 10 and negative when the line is to the left. Zero crossings indicate the horizontal point at which the antenna configuration is “centered” above the target line. The “zero crossing” in the center is a phase wrap. Note that current flowing in opposite directions tends to push the zero crossings outward from the line locations.

In FIG. 8, the largest response is from the Conventional LR antenna 120. The second largest response is from the Coaxial LR 124, the third from Twin Null LR 122, and the dual peaks meet at a null at X=3 is the Twin antenna. While the information obtained from all of these configurations is interesting, it will be appreciated that none of the antenna arrangements provide a clear signal of the line presence at X=2 or X=4, where the lines are actually located.

Current flow in the same direction may also occur. In this case the magnetic fields from the two lines 20, 22 will combine by superposition producing a wide response. In cases where the horizontal line separation is less than the line depth it can be difficult to tell there is more than one line present.

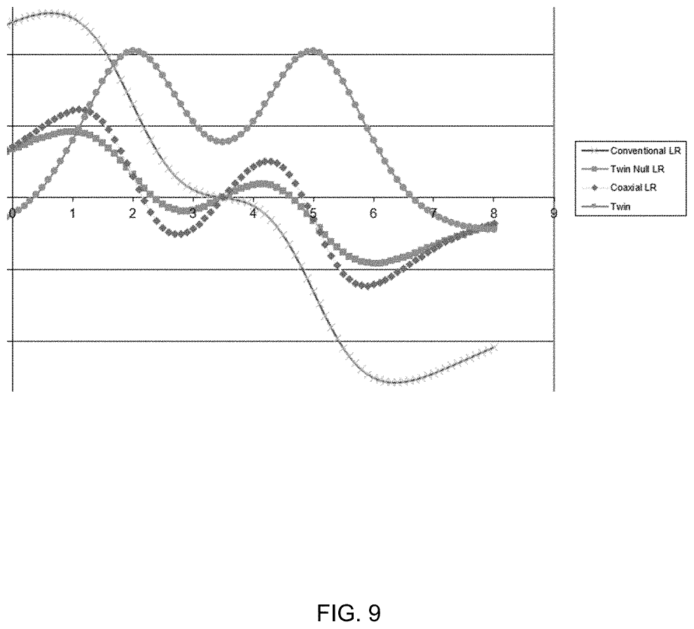

FIG. 9 is a plot of the signal response from the field shown in FIG. 4B. FIG. 4B shows the first line 20 at a=2 and the second line 22 at a distance c, which may be five units away, with current flowing in the same direction.

In FIG. 9 the parallel lines are too close together for the Conventional LR antenna 120 configuration to see two lines. The Coaxial LR 124 and Twin Null LR 122 configurations change polarity outside the center of the graph to indicate that there is more than one line.

The Coaxial Peak LR configuration 124 also differs from the other two LR configurations in that it does not contain a Null antenna. This is an advantage in the case where a second underground line 22 is nearby and reasonably perpendicular to the first line. The second line 22 would contribute a significant vertical magnetic field component which would distort the signal from any LR antenna configuration containing a null antenna 104.

Of the antenna configurations listed above, the Coaxial Peak Left-Right configuration 124 performs the best for accurately determining the Left-Right position of the locator when additional parallel lines are present. The present invention attempts to provide improvements to this configuration to provide meaningful signals in two- or multi-line environments.

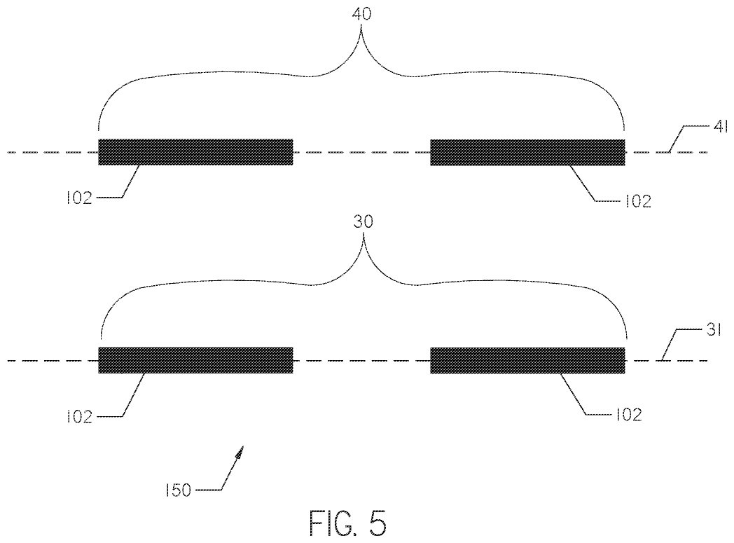

With reference now to FIGS. 3 and 5, a new arrangement 150, referred to as a “Twin Coaxial LR” configuration, is shown. The configuration 150 comprises a first, bottom pair 30 of peak antennas 102. The bottom pair 30 is coaxial about a first axis 31.

The first axis is preferably normal to the underground lines 20, 22. The configuration 150 further comprises a second pair 40 of peak antennas 102. The second pair 40 is coaxial about a second axis 41. The second axis 41 is parallel to the first axis 31 and thus also normal to the underground lines 20, 22. As used herein, the first pair 30 may be referred to as a “bottom pair” and the second pair 40 may be referred to as a “top pair”.

A LR signal is calculated from both coaxial pairs 30, 40. The locator 10 may have an onboard processor to process the received signals from each pair. The top coaxial LR signal is subtracted from the bottom coaxial LR resulting in a Twin Coaxial LR signal. As discussed above, it is advantageous in a multiple-line environment for no null antenna 104 to be present. Therefore, every antenna in the system may be either parallel to, or coaxial with, every other antenna in the system. Further, all the antennas will be substantially horizontal in orientation when the frame 12 is vertical.

It should be understood that the frame 12 is designed to be oriented vertically. However, as the frame 12 can be oriented in any manner, the axes 31, 41 are more particularly described as being perpendicular to a longitudinal axis 13 of the frame 12—that is, a line extending from a first end 60 to a second end 62 of the frame.

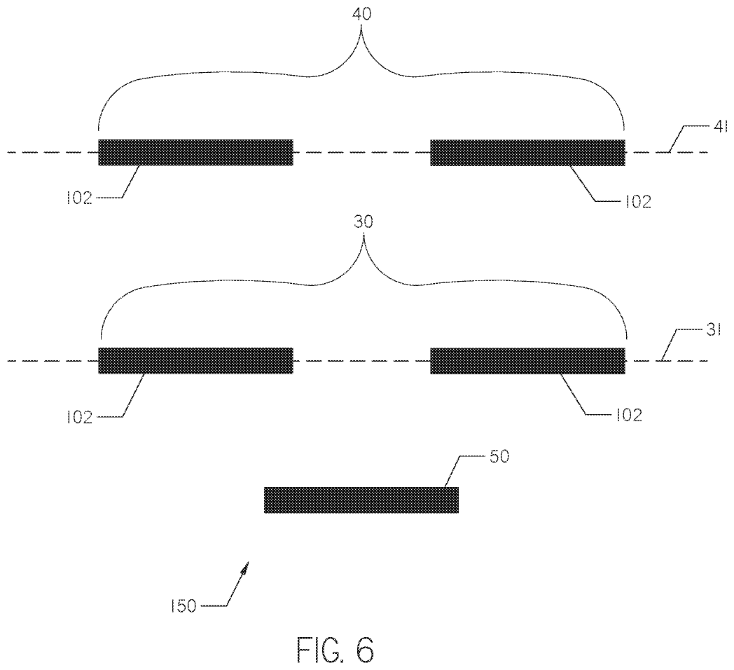

This arrangement 150 will work with a minimum of four peak antennas 102 oriented in two pairs 30, 40. However, as shown in FIG. 6, a phase reference peak antenna 50 may be utilized below and parallel to the first and second pairs 30, 40 for use as a phase reference. The locator 10 of FIG. 3 also includes this phase reference antenna 50.

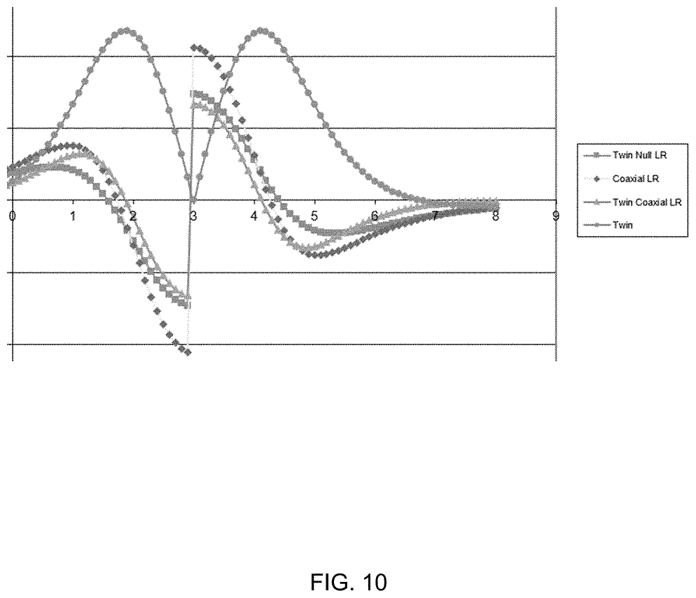

FIGS. 10-12 show plots of the performance of the Twin Coaxial Peak LR antenna configuration 150 relative to that of the Coaxial peak LR 124 and Twin Null LR 122. A Twin Peak 112 signal is shown for reference.

FIG. 10 is the field of FIG. 4A, as described above.

FIG. 10 represents a typical direct connect application where the 2^{nd} parallel line carries most of the return current. All configurations 122, 124, 150 show two lines 20, 22 in the ground, but the Twin Coaxial Peak 150 is closest to the actual line location at a=2 and b=4.

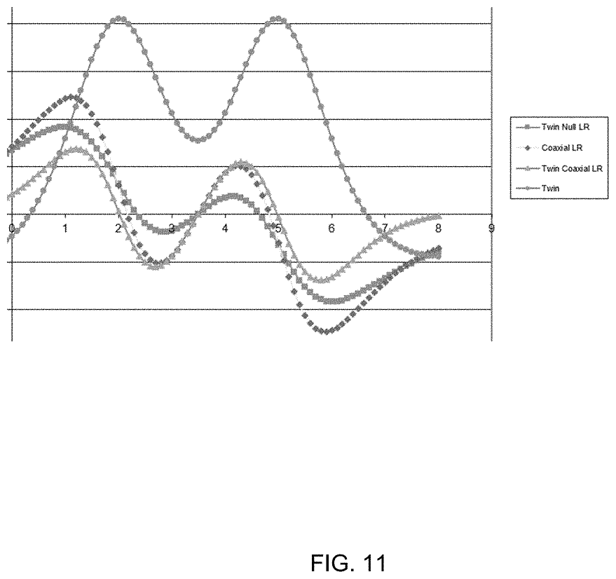

FIG. 11 is the field of FIG. 4B, as described above.

FIG. 11 represents a typical broadcast application where current is induced on both lines 20, 22 in the same direction. Because the lines 20, 22 are spaced far enough apart horizontally, all configurations show two lines in the ground. The Twin Coaxial Peak 150 is closest to the actual line location, with the Coaxial LR configuration 124 also being relatively close.

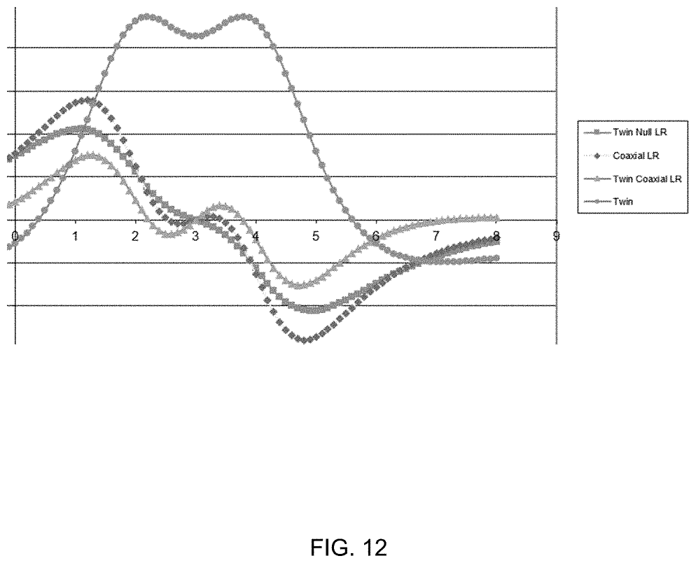

FIG. 12 is the field shown in FIG. 4C. This field is similar to that of

FIG. 4B, except that the first line is at a=2 and the second at b=4. As parallel lines get closer together, it becomes harder for a configuration of antennas to distinguish between the two lines and a single line.

The lines are now spaced close enough together horizontally relative to their depth that the Twin Null LR configuration 122 now indicates only a single line in the ground. The Coaxial LR configuration 124 is slightly better but an operator would still have a hard time identifying both line 20, 22 based on the LR signal. The Twin

Coaxial Peak 150 produces two clear zero crossings that are reasonably close to the locations where the twin signal is at its maximum.

In addition to generating signals that better represent the actual location of the lines 20, 22, the Twin Coaxial LR Antenna configuration 150 can also be used to detect the distortion caused by the presence of a second line in the ground.

The Twin LR antenna configuration 150 can be implemented with only four antennas 102. To do this, one or both of the bottom antenna signals can be used as a phase reference. The phase of the four antennas can then be compared to this reference to determine their relative phase. Using (BR-BL)/(BR+BL) for the bottom antenna LR signal and (TR-TL)/(BR+BL) for the top LR signal works well. The phase reference signal amplitude does go to zero when directly over a line 20, 22 but the LR signal will also go to zero at that point. Noise will also be an issue near the center of the line because BR-BL will be very small. Using the BR or the BL antenna as a reference shifts the horizontal zero point, and compensation for this will be required by the processor.

The use of four antennas may cause issues when very shallow lines are detected. To prevent this and the zero-point issue, the phase reference antenna 50 may be utilized. Using a dedicated bottom peak antenna enables use of that antenna as a phase reference. This provides a stable phase reference with its amplitude maximized when directly over the line. The strong reference allows the use of less sensitive LR antennas to reduce cost and weight.

One skilled in the art could conceive modifications to the concept that would result in slight differences. Examples of this are the use or air core vs. ferrite core antennas, winding geometries, changes to antenna angles that break strict parallel or perpendicular geometry, and similar mathematical combinations of antennas.

The various features and alternative details of construction of the apparatuses described herein for the practice of the present technology will readily occur to the skilled artisan in view of the foregoing discussion, and it is to be understood that even though numerous characteristics and advantages of various embodiments of the present technology have been set forth in the foregoing description, together with details of the structure and function of various embodiments of the technology, this detailed description is illustrative only, and changes may be made in detail, especially in matters of structure and arrangements of parts within the principles of the present technology to the full extent indicated by the broad general meaning of the terms in which the appended claims are expressed.

What is claimed is:

1. A locator for use in an above-ground region characterized by a magnetic field emanating from one or more below-ground utility lines, the locator comprising:
a first pair of antennas spaced apart along a first axis;
a second pair of antennas spaced apart along a second axis;
wherein the first axis and second axis are spaced apart and parallel; and
a processor configured to:
receive signals indicative of the magnetic field from the first pair of antennas and the second pair of antennas; and
using the signals, determine a location of the below-ground utility lines.

2. The locator of claim 1 having a phase reference antenna disposed along a third axis, wherein the third axis is spaced apart from and parallel to the first axis and the second axis.

3. The locator of claim 2 wherein the locator is configured such that the first axis, the second axis, and the third axis are substantially horizontal.

4. The locator of claim 2 wherein the third axis is located below the first axis, and wherein the first axis is located below the second axis.

5. The locator of claim 1 in which no antenna is oriented along an axis which is perpendicular to any other antenna.

6. A method, comprising:
placing the locator of claim 1 in the above ground region;
transmitting a signal from the at least two underground lines;
at the first above ground location, detecting the signal from the at least two underground lines with the first pair of antennas;
simultaneously, detecting the signal from the at least two underground lines with the second pair of antennas;
thereafter, moving the locator to a second above ground location;
at the second above ground location, detecting the signal from the at least two underground lines with the first pair of antennas;
simultaneously, detecting the signal from the at least two underground lines with the second pair of antennas; and
using the signals, estimating a location of the at least two underground lines.

7. A method, comprising;
placing the locator of claim 1 at a first above ground location in the above ground region;
transmitting a signal from the at least two underground lines;
at the first above ground location, detecting the signal from the at least two underground lines with the first and second pair of antennas;
moving the locator to a second location where a detected phase amplitude is zero; and
moving the locator to a third location where a detected phase amplitude is zero.

8. The method of claim 7 further comprising:
marking a detected location of a first line of the at least two underground lines at the second location; and
marking a detected location of a second line of the at least two underground lines at the third location.

9. The locator of claim 1, further comprising:
a frame having a first end and a second end; and
a handle disposed at a first end of the frame;
wherein the first pair of antennas are disposed closer to the second end than the first end of the frame; and
wherein the second pair of antennas are disposed between the first pair of antennas and the first end of the frame.

10. The locator of claim 9, in which the first axis and the second axis are perpendicular to a line between the first end and the second end of the frame.
